(19) United States
(12) Patent Application Publication
(10) Pub. No.: US 2021/0364669 A1
(43) Pub. Date: Nov. 25, 2021

(54) MULTI-WELL INTERFERENCE CONTROL AND MITIGATION

(71) Applicant: Halliburton Energy Services, Inc., Houston, TX (US)

(72) Inventors: Ronald Glen Dusterhoft, Katy, TX (US); Stanley Vernon Stephenson, Duncan, OK (US); Mikko Jaaskelainen, Katy, TX (US)

(21) Appl. No.: 16/878,053

(22) Filed: May 19, 2020

(51) Int. Cl. G01V 99/00; E21B 47/06; E21B 47/07; E21B 49/00; E21B 43/267

(52) U.S. Cl. CPC G01V 99/005; E21B 47/06; E21B 2200/20; E21B 49/00; E21B 43/267; E21B 47/07

(57) ABSTRACT

Multi-well fracture control incorporates physical well properties into a model for fracture geometry to determine optimal mitigation techniques for well interference effects. Sensors in a monitoring well and a treatment well measure well properties during fluid injection and pumping in the treatment well. The measurement data is used to constrain fracture geometry model. The fracture geometry model is then used to calculate fracture growth rates and direction which are used to calculate an estimated time for the occurrence of well interference effects in the multi-well system. From the fracture geometry model, fracture growth rates and direction, and the estimated time for the occurrence of well interference, locations of potential well interference effects are predicted. A mitigation strategy is planned based on the predicted location and time of well interference events. Treatment actions can be taken in anticipation of the well interference events.

### TECHNICAL FIELD

The disclosure generally relates to the field of earth or rock drilling and to surveying and testing of boreholes and wells.

### BACKGROUND

Well interference occurs when the operation of one well causes an adverse effect on the operation of another, adjacent well. Well interference between adjacent or otherwise spatially related wells may result in reduction or fluctuation in hydrocarbon production for a production well due to fluid communication with a nearby injection well. Well interference in an injection well may result in a substantially uneven or otherwise distorted hydraulic fracture patterns due to lower formation pressure near the production well. The fracture pattern distortion is caused by the pressure gradient between the formation material surrounding the injection well and the formation material surrounding the production well. The formation material surrounding the injection well has a higher pressure due to fluid injection, and the formation material surrounding the production well has a lower pressure due to depletion of formation fluids. So called “frac-hits” are interference events in which fluid injection activity in the form of hydraulic fracturing forces a portion of the injected fluid to invade a production formation zone. Frac-hits may be referred to as a form of parent-child well interference in which injection fluid from a child well invades a neighboring parent well.

Interference testing may be utilized to detect whether well interference has occurred. Interference testing may include measuring formation pressure over time in or near a first well, referred to as a monitoring well, that is adjacent to a hydraulic fracturing well, referred to as an injection well. The formation pressure for the first well may be measured prior to, during, and/or following injection operation cycles to detect correlations between fluid injection and pressure variation of the first well formation.

### BRIEF DESCRIPTION OF THE DRAWINGS

Embodiments of the disclosure may be better understood by referencing the accompanying drawings.

FIG. 1 is a diagram of a process for multi-well fracture control.

FIG. 2 is a flowchart of operations for multi-well hydraulic fracture control with a measurement constrained fracture geometry model.

FIG. 3 is an isometric view of an electrically driven multi-well system with distributed fiber optic sensors and point sensors.

FIG. 4 is an isometric view of an electrically driven multi-well system with an electro acoustic technology (EAT) sensing system.

FIG. 5 is an isometric view of an electrically driven multi-well system with a combination of distributed fiber optic sensors, point sensors, and EAT sensors.

FIG. 6 is an elevation view of a borehole that includes a DAS system connected to an optical fiber within the tubing of a cased borehole.

FIG. 7 is an elevation view of a borehole that includes a DAS system connected to an optical fiber fixed to the outside of the tubing of a cased borehole.

FIG. 8 is an elevation view of a borehole that includes a DAS system connected to an optical fiber fixed to the outside of the production casing of a cased borehole.

FIG. 9 is an example computer system for multi-well fracture control.

### DESCRIPTION OF EMBODIMENTS

The description that follows includes example systems, methods, techniques, and program flows that embody embodiments of the disclosure. However, it is understood that this disclosure may be practiced without these specific details. For instance, this disclosure refers to a first well to be treated and a second well to be monitored in illustrative examples. Embodiments of this disclosure can be instead applied for monitoring the first well and treating the second well, or the well to be monitored and the well to be treated may be switched during the process. In other instances, well-known instruction instances, protocols, structures and techniques have not been shown in detail in order not to obfuscate the description.

### Overview

Investigating the effect of well interference through frac-hits in reservoirs provides information on the viability of production and treatment wells. Models and simulations of subsurface environments surrounding multi-well systems can be used to better understand the potential for well interference. Current modelling techniques simulate fracture geometry, fluid injection, and pressure loading responses. While these models provide information on the historic and current state of fractures, the current modelling techniques lack reliable information to predict future fracture growth and well interference events and to plan well interference effect mitigation. Thus, a technique is disclosed for measuring, predicting, and mitigating well interference events.

A multi-well fracture control strategy incorporates physical well properties into a model for fracture geometry to determine optimal mitigation techniques for well interference effects. Sensors in a monitoring well and a treatment well measure well properties during fluid injection and pumping in the treatment well. The sensors monitor parameters in the wells to enable prediction of well interference effects. The sensors measure pressure, temperature, acoustic response, and strain in a formation surrounding the multi-well system. The measurement data is used to constrain fracture geometry model to a modelled realization of the earth formation. Constraining the model with measured well parameters improves the accuracy of the model and subsequent calculations and predictions by assuring the model matches the physical environment surrounding the wells. The fracture geometry model is then used to calculate fracture growth rates and direction. The fracture growth rates and direction are used to calculate an estimated time for the occurrence of well interference effects in the multi-well system. From the fracture geometry model, fracture growth rates and direction, and the estimated time for the occurrence of well interference, locations of potential well interference effects are predicted. A mitigation strategy can be planned based on the predicted location and time of well interference events. Treatment actions, such as pressure loading, or pump rate reduction, can be taken in anticipation of the well interference events to mitigate detrimental impact in the monitoring well.

The multi-well fracture control operations constrain the model based on measurement data to provide a more accurate model. Monitoring well parameters during fluid injection and pumping combined with the ability to predict the location of well interference effects enables better understanding of the effects of frac-hits in the multi-well system. Additionally, electrical fracturing equipment may be used to pump fluids in the wellbores. The use of electrical fracturing equipment provides a low noise environment for the sensors and allows for more accurate control of the pump rate and pressure within the wells as treatment actions are taken to mitigate well interference effects.

### Example Illustrations

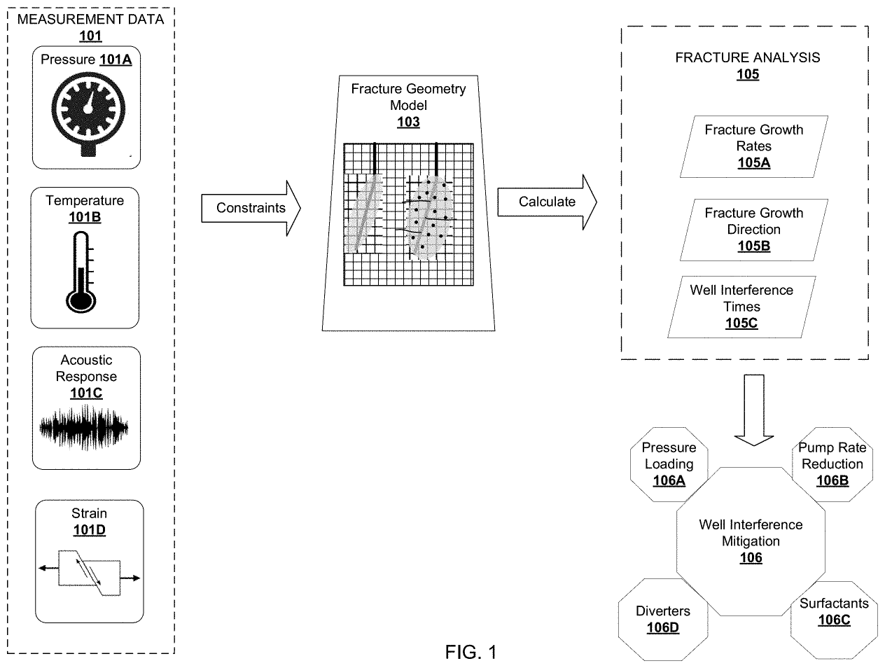

FIG. 1 is a diagram of multi-well fracture control operations. FIG. 1 depicts a process through which measurement data is used to constrain a fracture geometry model. Fracture analysis is performed based on the fracture geometry model. The analysis is implemented into well interference mitigation strategies. A well interference mitigation system for multi-well fracture control senses well parameters in a treatment (child) well and a monitoring (parent) well. Sensors in and around each well obtain measurements or measurement data 101 for each well. Measurement data 101 includes measurements for pressure 101A, temperature, 101B, acoustic response 101C, and strain 101D. Pressure 101A may be measured by pressure sensors on the surface and subsurface pressure sensors for each well. The pressure sensors may include sensors capable of taking high accuracy, high resolution low frequency data. The pressure sensors may also be capable of taking high frequency data with high resolution data. Combining surface and sub-surface sensors and the ability to record high and low frequency data allows a broad spectrum of pressure data to be recorded at various depths in each well. Distributed fiber optic sensors in the treatment well and/or the monitoring well measure temperature 101B, acoustic response 101C, and strain 101D continuously along the full length of the optical fiber. The distributed sensors may be cemented behind the casing in the treatment well or in the monitoring well. The distributed fiber optic sensors may also be placed in the monitoring well using coiled tubing, wireline, or loose fiber using coiled tubing or gravity deployed fiber coils that unwind as the fiber coil is moved in the well. The distributed fiber optic sensors perform distributed temperature sensing, distributed acoustic sensing, and distributed strain sensing. Distributed temperature sensing (DTS) measures the temperature change in the fluid in the monitoring well as a result of direct fluid communication between drilling fluids and formation fluids. Distributed acoustic sensing (DAS) measures acoustic responses and determines microseismic events through the detection of shear waves and/or pressure waves. Distributed strain sensing (DSS) measures deformations in the earth and how the earth reacts to frac hits to determine number, location, and direction of fractures in the formation. The downhole sensors communicate the DTS, DAS, and DSS data to sensing system interrogation units at the surface or a remote location, and the optical fiber is both the sensor and the communication path to the surface interrogation unit. Several different types of down-hole point sensors may be used where some point fiber optic sensors may be added in the fiber optic cable in a quasi-distributed manner or at the end of the fiber optic cable. These fiber optic sensors may be based on Fabry-Perot, Michelson, Mach-Zehnder or other interferometric sensing principles. Other point sensors may be electrical where the point downhole sensor may have batteries, sensors and acoustic transducers. The point sensor may then collect sensor data, process sensor data and acoustically transmit sensor data by modulating intensity and/or frequency. The acoustic intensity and/or frequency may then perturb the optical fiber such that the distributed acoustic sensing system detects the perturbations. The distributed acoustic sensing system or a computer connected to the acoustic sensing system then converts the acoustically communicated information to the property measured by the downhole sensors. The electrical downhole sensors may also be located in plugs throughout the well, where the point sensors acoustically transmit sensor data that may be collected with a distributed acoustic sensing system.

The measurement data 101 is used to constrain a fracture geometry model 103. The fracture geometry model 103 can be used to provide an image of subsurface fracture systems based on simulation of fracture growth rates and directions, as well as time and location of well interference events with the fracture geometry model 103. The fracture geometry model 103 may be one of, or a combination of, a geomechanical model and a finite element grid, as examples. Hydraulic fracture geometry is a function of initial reservoir stress conditions, rock properties of the formation surrounding the wells, permeability, porosity, natural fracture systems, and well operation conditions. Historical data is used to populate the model for conditions like rock properties and natural fracture systems, but some assumptions are typically used to obtain a fracture geometry model. By constraining the fracture geometry model 103 based on the measurement data 101, the model becomes less dependent on assumptions and provides a more accurate representation of the formation near the wells. The measurement data 101 is used to constrain flow allocation from the pressure 101A and temperature 101B measurement data and the acoustic data 101C, as well as define microdeformation and microseismic events from the measured acoustic response 101C and strain 101D measurement data. The acoustic data 101C can be used for flow allocation in the injection well, microseismic monitoring in the injection or monitoring well, strain sensing in the injection and monitoring well. The flow, microseismic and strain models may use the distributed acoustic data in different models and may also filter and process the data over frequency and amplitude before the processed output may be used in a model or calculation. Using data from distributed sensors throughout the wells reduces the uncertainty of the fracture geometry model 103.

Fracture analysis 105 is performed based on the fracture geometry model 103. Fracture growth rates can be calculated based on the fracture geometry model 103 and the measurement data for pressure 101A and strain 101D. Hydraulic fracturing occurs when pressure within the formation exceeds the principal stress and tensile strength of the rock. Stress can be calculated from strain using Young's Modulus. Continued pumping of hydraulic fluid in the well at increasing pressures causes the fracture to propagate in the direction of least resistance. The fracture geometry model 103 includes information on the rock properties in the formation as well as the pressure and strain downhole which allows growth rates to be calculated at varying distances from the wells. Fracture growth direction 105B can be determined based on the fracture growth rates and the strain measurements. Based on the fracture growth rates 105A and fracture growth direction 105B, well interference times 105C can be estimated. Well interference times 105C are predictions of where and when a fracture will impact the monitoring well. Based on the fracture analysis 105, a strategy for well interference mitigation 106 is determined. Possible well interference mitigation strategies include pressure loading 106A, pump rate reduction 106B, and/or adding surfactants 106C and diverters 106D. Pressure loading 106A may include injecting water and/or gas in a well at a low injection rate, injecting water and/or gas in a well at a high injection rate, or re-fracturing a well using high rate injection with water, diverters, and/or proppants. Gases injected during pressure loading 106A may include nitrogen, carbon dioxide, and/or natural gas.

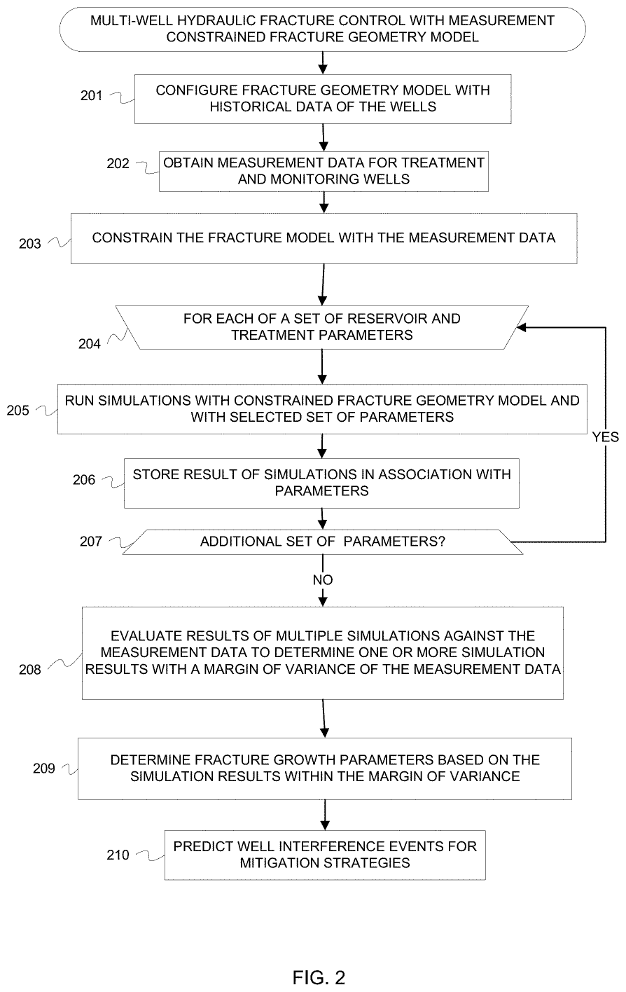

FIG. 2 is a flowchart of operations for multi-well hydraulic fracture control with a measurement constrained fracture geometry model. FIG. 2 includes operations that can be performed by hardware, software, firmware, or a combination thereof. For example, at least some of the operations can be performed by a processor executing program code or instructions. The description refers to a program code that performs operations as a “fracture geometry simulator” although it is appreciated that program code naming and organization can be arbitrary, language dependent, and/or platform dependent. Operations of the flowchart of FIG. 2 start at block 201

At block 201, a fracture geometry simulator configures a fracture geometry model with historical data of a treatment well and a monitoring well. The fracture geometry model is a geomechanical model of the formation. The fracture geometry model establishes earth parameters of the formation such as shape and size of one or more fractures. Historical data is used to populate the model for conditions like rock properties and natural fracture systems to obtain an accurate fracture geometry model of the formation.

At block 202, the fracture geometry simulator obtains measurement data for the treatment well and the monitoring well. Sensors in a monitoring well and sensors in a treatment well monitor well and reservoir properties while pumping fluid in a treatment well. The sensors may be downhole or on the surface of each well and may have batteries, sensors and acoustic transducers, and may be located in plugs or deployed inside or outside of the well casing. The sensors monitor properties in the treatment well and in the monitoring well. Measurements may be taken separately for each well or simultaneously. Multiple sensors distributed throughout the wells may be used to record a variety of well properties. For example, surface pressure sensors may be used to take high accuracy, high resolution low frequency data and/or high frequency data with high resolution. Subsurface pressure sensors may take similar frequency and resolution measurements at locations distributed throughout the wells to obtain more accurate results. In addition to pressure sensors, distributed fiber optic sensors, such as temperature, pressure, and acoustic sensors, are used to measure flow allocation, microdeformation monitoring, and microseismic monitoring by measuring pressure and shear waves. The measurements from the various downhole sensors may be acoustically communicated to a distributed acoustic sensing (DAS) system, or fiber optic sensors may be connected to surface interrogation units to convert the measured information to downhole properties. The DAS system converts the acoustically communicated information to the property that the downhole sensors measured. The fracture geometry simulator obtains the converted measurements from the DAS system, the DTS system, the strain system or from a pressure sensing system or from a repository in which the measurements are stored.

At block 203, the fracture geometry simulator constrains the fracture geometry model configured with historical data with the obtained measurements. The fracture geometry simulator couples the measurement data to the historical fracture geometry model to adjust and fine tune the modeled output. Based on the coupling of the measurement data to the historical fracture geometry model, the fracture geometry simulator generates a representative fracture geometry model. The fracture geometry simulator configures the mechanical properties of the rock, pore pressure, process zones, and stress forces near fracture tips based on the measurement data as constraints on the historical fracture geometry model. For example, incorporating DSS data into a fracture geometry model provides an image of changes in ground deformation.

The fracture geometry simulator may also generate two models, a historical fracture geometry model and a current fracture geometry model representing the measurement data. These two models can be coupled together so that updating the current fracture geometry model with new measurement data is reflected in the coupled historical and current fracture geometry models. Comparing the two models allows for a determination of critical modelling parameters in the formation. Coupling the models allows for matching simulated formations to the physical formation. The constrained fracture geometry model and/or the coupled historical and current fracture geometry models serve as a representative geomechanical model that incorporates historical data and measured well and formation properties to represent the multi-well system and surrounding formation.

At block 204, the fracture geometry simulator defines various sets of reservoir and treatment parameters. The defined reservoir and treatment parameters are used for sensitivity analysis of the fracture geometry model. Reservoir parameters may include formation stress and/or pore pressure. Treatment parameters are operational parameters that can be changed relatively easily such as injection rate, fluid volume, proppant concentration, diverting agents, number of perforations, number of perforation clusters, and/or number of perforations per cluster. Each set of reservoir and treatment parameters is analyzed separately.

At block 205, the fracture geometry simulator runs simulations with the configured fracture geometry model for one of the defined sets of reservoir and treatment parameters. The fracture geometry simulator runs simulations using the configured fracture geometry model as a starting point since the configured fracture geometry model represents the current configuration of the earth formation surrounding the multi-well system. Multiple simulations are run with varying sets of parameters input into the configured fracture geometry model. The input parameters may include reservoir parameters and/or treatment parameters. The multiple simulations with varying input parameters simulate multiple predictive models or realizations that predict how a fracture will grow in response to the various input parameters. Each realization represents a different sensitivity of the reservoir and model parameters to the varying input parameters, such as pressure, temperature, or strain. Multiple realizations are simulated based on specific changes in well and reservoir conditions. Each simulation varies one set of parameters to determine how that specific set of parameters impacts fracture growth. Sets of parameters may also be combined to visualize the impact of multiple parameters acting simultaneously on fracture growth. For example, a first simulation may be run predicting fracture growth at a specific pressure parameter. The pressure parameter may then be increased, and another simulation run, to create a realization predicting fracture growth at the second pressure parameter. This process can be repeated for multiple pressures to create multiple realizations representing a range of typical pressures in the downhole environment.

At block 206, the fracture geometry model stores the result of the simulations in association with the parameters. The results may be stored on the same device running the fracture geometry model or the results may be communicated to an external device for storage.

At block 207, the fracture geometry simulator determines if there are additional sets of parameters to analyze. If there are, operations return to block 203. If there are no additional sets of parameters left to analyze, operations continue to block 207.

At block 208, the fracture geometry simulator evaluates the results of multiple realizations against the measurement data to determine one or more realizations results within a margin of variance of the measurement data. The fracture geometry simulator compares the multiple realizations for each set of parameters to identify which reservoir parameter has a significant impact on the modelling outputs. The fracture geometry simulator selects the one or more realizations from the multiple simulated realizations that are most representative of the formation. The fracture geometry simulator uses a margin of variance to select realizations most representative of the formation. The margin of variance may be set for one or more reservoir parameter and may be pre-defined, or it may be defined based on the output results. For example, fracture height may be the selected parameter. The margin may then be defined by a percent difference in which all realizations with a fracture height within 5% of a measured fracture height are selected. The margin may also be defined based on number of realizations. For example, if 100 realizations were output, the ten realizations most accurately matching the measurement data for a set parameter are selected.

At block 209, fracture growth parameters are determined based on the results of the realizations within the margin of error. The realization or realizations most representative of the formation are used as an input in the fracture geometry simulator. The fracture geometry simulator progresses a fracture growth model based on the selected realizations and known pumping rates and/or flow allocation rates in the treatment well. The position and length of hydraulic fractures are simulated over time. Fracture growth rate is calculated from the length of the hydraulic fracture and the time of the simulation. Microseismic data from the DAS measurements are used to calculate fracture growth direction from the treatment well.

At block 210, well interference events are predicted based on the determined fracture growth parameters. The determined fractured growth parameters are used to predict the location and timing of well interference events. The fracture geometry simulator estimates a location of well interference event occurrence based on the fracture growth parameters determined from the predictive realizations within the margin of error. The fracture geometry simulator may use the results and growth parameters from one realization or may average multiple realizations to extrapolate fractures from the treatment well to the monitoring well. The fracture growth rate and fracture path determine the well interference event timing.

The well interference events are used to determine a mitigation strategy. Based on the predicted well interference event, the fracture geometry simulator can select a mitigation option. Well interference events can be mitigated by stopping or reducing the pumping rate in the treatment well, by using diverters in the treatment well, by changing proppant concentrations or by pressure loading the monitoring well. Surfactants and other production enhancing chemicals may also be incorporated during pressure loading. The fracture geometry simulator uses fracture analysis data to assess mitigation strategies. For example, a lower pressure in the monitoring well than in the treatment well is indicative of pressure depletion in the monitoring well. Fractures grow from areas of high pressure taking a path of least resistance, typically through areas of low pressure. A negative pressure differential may increase the probability of a well interference event and may also speed up the timing or increase severity of an event. Thus, increasing the pressure in the monitoring well through increased pumping rates or plugs reduces the potential for well interference events. Pressure may also be controlled in the treatment well to further mitigate well interference events. Proppants may be added, or the concentration may be varied in either well to change the viscosity of fluids and induce a pressure change in the formation that is likely to reduce well interference events.

The determined mitigation strategies are implemented to mitigate well interference. The fracture geometry simulator communicates with a treatment well controller and a monitoring well controller the determined mitigation strategy. Based on the communicated strategy, the controllers implement the strategy by controlling the pumping rate of fluids in each well. Continued monitoring of the fluid flow in the monitoring well during pressure loading enables an assessment of the effectiveness of the mitigation strategy. Electrical frac equipment may be used to pump fluids in the wells and control pumping rates. Electrical frac equipment provides a low noise environment for the sensors which reduces interference in the measurements, particularly the pressure measurements. Electrical frac equipment increases accuracy in controlling rate and pressure as mitigation actions are performed. Operations of blocks 202-209 may be repeated with the new measurements obtained during pressure loading to assess the effectiveness of pressure loading and determine whether further mitigation strategies should be implemented. For instance, after an initial pressure loading mitigation strategy was determined, an additional mitigation strategy including dropping diverters may be selected to further delay well interference events.

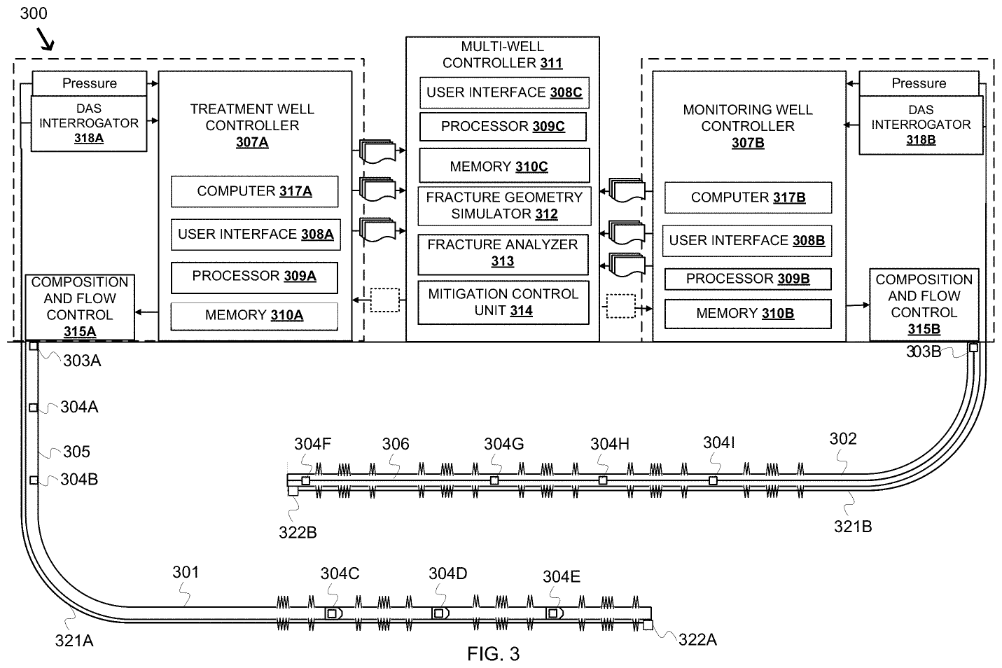

FIG. 3 is an isometric view of an electrically driven multi-well system with distributed fiber optic sensors and point sensors. An electrically driven multi-well system 300 comprises two wells and infrastructure for pumping and monitoring each well. The multi-well system 300 depicted in FIG. 3 is comprised of a treatment well 301 and a monitoring well 302. Each well contains multiple sensors. Sensors may be at the surface of each well, such as sensors 303A and 303B, or sensors may be at various locations downhole, such as sensors 304A-I. The sensors may be pressure sensors, distributed fiber optic sensors, point temperature sensors, point acoustic sensors, or point strain sensors. Distributed fiber optic sensors are capable of measuring distributed acoustic data, distributed temperature data, or distributed strain data. Sensors 304A and 304B are cemented outside the casing 305 of the treatment well 301 while sensors 304C-E are located in plugs downhole. The sensors 304F-I in the monitoring well 302 are distributed along a fiber 306. Fiber optic cables, such as fiber optic cable 321A and fiber optic cable 321B are also used to obtain measurements in addition to the sensors. Fiber optic cables 321A-B may be cemented in place in the annular space between the casing of the well and the formation. The fiber optic cables 321A-B may be clamped to the outside of the casing during deployment and protected by centralizers and cross coupling clamps. The fiber optic cables 321A-B may house one or more optical fibers, and the optical fibers may be single mode fibers, multi-mode fibers, or a combination of single mode and multi-mode optical fibers. Additional point sensors, such as pressure point sensors 322A-B, are included at the end of the fiber optic cables 321A-B to obtain measurements at the end of the wells 301 and 302. Pressure point sensors 322A-B may be optical or electrical sensors. While depicted as attached to the fiber optic cables 321A-B in FIG. 3, pressure point sensors 322A-B may alternatively be housed in dedicated gauge mandrels or attached outside the casing in various configurations for down-hole deployment or deployed conventionally at a surface well head or flow line.

Optical fiber 306 and fiber optic cables 321A-B in wells 301 and 302 may be used for distributed sensing where acoustic, strain, and temperature data are collected. The data may be collected at various positions distributed along the optical fibers or fiber optic cables. For example, data may be collected every 1-3 ft along the full length of the optical fiber or fiber optic cable. The fiber or cable may be included with coiled tubing, wireline, loose fiber using coiled tubing, or gravity deployed fiber coils that unwind the fiber as the coils are moved in the well. The distribution of sensors shown in FIG. 3 is for example purposes only. Any combination of sensor deployment described may be used in either well. For example, the treatment well may include fiber deployed sensors while the monitoring well contains sensors cemented into the casing. Different types of sensors deployments may also be combined in a single well, such as the treatment well 301 including both sensors cemented to the casing and sensors in plugs.

The sensors acoustically communicate measurements to a respective well controller through an interrogator. Fiber optic cable 321A and sensors 303A and 304A-E acoustically communicate measurements to a DAS interrogator 318A. Fiber optic cable 321B and sensors 303B and 304F-I acoustically communicate measurements to a DAS interrogator 318B. The interrogators 318A-B decode signals received from the downhole fiber optic cables and sensors to provide useful information to well controllers 307A-B at the surface. Well controller 307A is the controller for the treatment well 301 while well controller 307B is the controller for the monitoring well 302. The pressure point sensors 322A and 322B may communicate pressure data to the well controllers 307A-B directly. The sensors 322A-B may also communicate data to the well controllers 307A-B through the DAS interrogators 318A-B. The treatment well controller 307A and the monitoring well controller 307B include computers 317A and 317B, respectively. The treatment well controller also includes a user interface 308A, processor 309A and memory 310A. The monitoring well controller includes a user interface 308B, a processor 309B, and a memory 310B. The well controllers 307A-B allow each well to be monitored and controlled individually. Each well controller 307A-B communicates data to a multi-well controller 311. The multi-well controller 311 may be hardwired to communicate with the treatment well controller 307A and the monitoring well controller 307B, or communication between the controllers may be wireless. The multi-well controller 311 includes a user interface 308C, a processor 309C, and a memory 310C. The multi-well controller 311 also includes a fracture geometry simulator 312, a fracture analyzer 313, and a mitigation control unit 314. The fracture geometry simulator 312 simulates fracture geometries based on the measurements communicated from the sensors through the well controllers. The fracture analyzer 313 calculates fracture growth parameters based on the simulated fracture geometries. The mitigation control unit 314 determines a strategy for mitigating well interference events based on the fracture growth parameters. The multi-well controller 311 communicates the determined mitigation strategy to the treatment well controller 307A and the monitoring well controller 307B. The treatment well controller 307A sends a signal to a composition and flow control 315A that controls pumping of fluids in the treatment well 301. The monitoring well controller 307B sends a signal to a composition and flow control 315B that controls pumping of fluids in the monitoring well 302. The composition and flow controllers 315A and 315B include hardware and software to operate electrical frac equipment (not pictured) that pumps fluid in the wells.

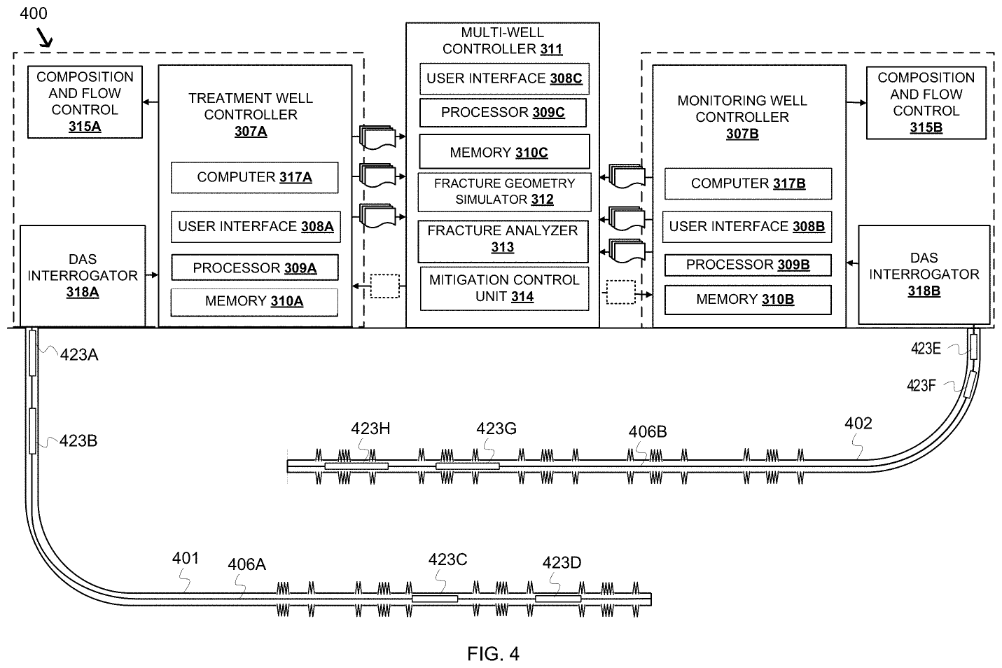

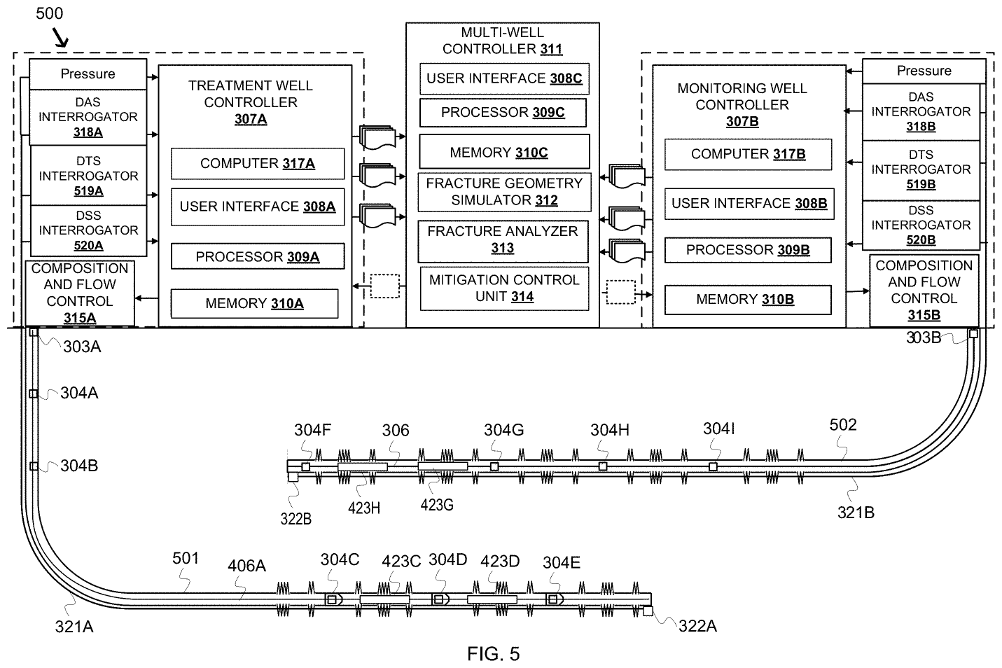

FIGS. 4 and 5 depict example embodiments of multi-well systems similar to multi-well system 300 of FIG. 3. As such, like numerals between the figures represent the same element of a multi-well system and will not be described in detail again.

FIG. 4 is an isometric view of an electrically driven multi-well system with an electro acoustic technology (EAT) sensing system. A multi-well system 400 comprises a treatment well 401 and a monitoring well 402. The treatment well 401 includes EAT sensors 423A-D distributed along an optical fiber 406A. The monitoring well 402 includes EAT sensors 423E-H distributed along an optical fiber 406B. In FIG. 4, the EAT sensors 423A-H and the fibers 406A-B are depicted within a casing of the wells 401 and 402. In some applications the EAT sensors 423A-H and the fibers 406A-B may be outside the casing of the wells 401 and 402. The fibers 406A-B are deployed through the well and back to the surface. The fibers 406A-B may be clamped to the EAT sensors 423A-H to ensure good transmission of signals. The fibers 406A-B exit the wells 401 and 402 and are connected to DAS interrogators 318A-B. The DAS interrogators 318A-B may have a laser source that fires interrogation pulses down through the fibers 406A-B and receives backscattered light back from the fiber optic cable. The fibers 406A-B are used as a sensor to detect acoustic signals along the entire length of the fiber. The DAS interrogators 318A-B at the surface decode the signals to provide useful information to the treatment well controller 307A and a monitoring well controller 307B. The EAT sensors 423A-H may contain orthogonal arrays of accelerometers, micro seismic sensors, and perhaps other sensors, signal processing, batteries and transmission transducers. The EAT sensors 423A-H are capable of measuring pressure, temperature, and vibration.

While not depicted, additional electrical sensors may be placed in the wells 401 and 402. These sensors may be cemented to the casing of the well and directly communicate with the well controllers 307A-B. The additional electric sensors may also communicate with the well controllers 307A-B through one or more fibers, such as fibers 406A-B. Electrical sensors may be pressure sensors based on quarts type sensors, strain gauge-based sensors, or other commonly used sensing technologies.

FIG. 5 is an isometric view of an electrically driven multi-well system with a combination of distributed fiber optic sensors, point sensors, and EAT sensors. FIG. 5 depicts a multi-well system 500 comprised of a treatment well 501 and a monitoring well 502. The wells 501 and 502 contain a combination of sensors from the wells 301 and 302 of FIG. 3 and the wells 401 and 402 of FIG. 4. In addition to the DAS interrogators 318A and 318B as described in FIGS. 3 and 4, FIG. 5 includes DTS interrogators 519A and 519B and DSS interrogators 520A and 520B. Combining multiple sensor types provides a variety of measurement methods in multiple locations throughout the wells. The measurements and data obtained by the sensors are communicated from the sensors to well controllers 307A and 307B. The communication can either be direct communication from the sensors to the controllers, or the communication can be from the sensors to an interrogator which is in communication with one of the controllers.

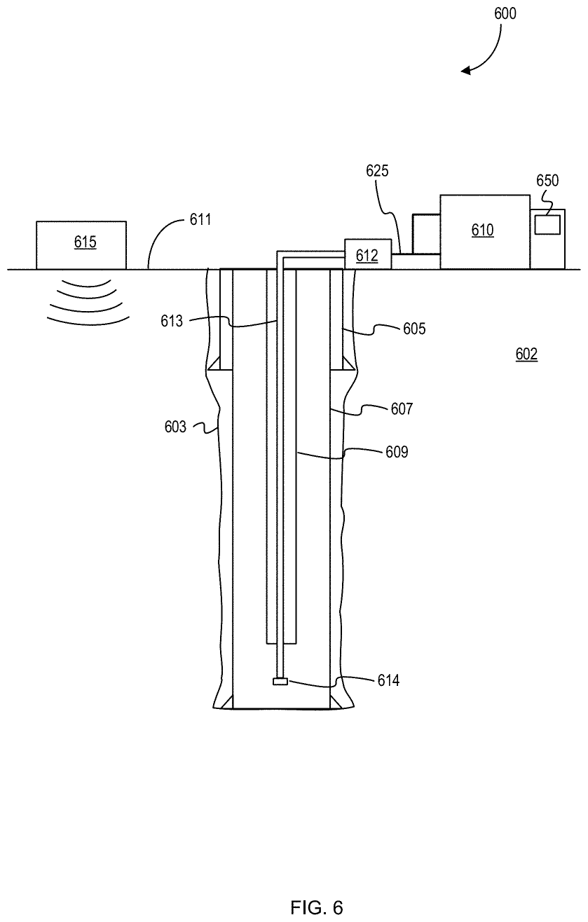

FIGS. 6-8 depict examples of DAS signal acquisition systems, such as the DAS system described in FIG. 2 or the DAS systems 317A or 317B of FIGS. 3-5. While FIGS. 6-8 depict an example of a DAS signal acquisition system in a single well, these systems may also be applied to a multi-well system.

FIG. 6 is an elevation view of a borehole that includes a simultaneous DAS signal acquisition system connected to an optical fiber within the tubing of a cased borehole. A borehole 603 in the subterranean formation 602 includes a DAS system 600 that can detect seismic disturbances generated by a seismic source 615 on an earth surface 611. The borehole 603 is a completion well (i.e. a well ready for production or injection following a drilling process) having a surface casing 605, a production casing 607 inside the surface casing 605, and a tubing 609 inside the production casing 607. In some embodiments, the tubing 609 can be a casing string, production string, an armored wireline, a slickline, a coiled tubing, a work string, etc. The DAS system 600 includes an optical fiber 613 in the tubing 609 and a DAS signal acquisition system 612 that includes a DAS interrogator.

The DAS interrogator in the DAS signal acquisition system 612 is directly coupled to the optical fiber 613. Alternatively, the DAS interrogator can be coupled to a fiber stretcher module in the DAS signal acquisition system 612, wherein the fiber stretcher module is coupled to the optical fiber 613. The DAS signal acquisition system 612 can receive DAS measurement values taken and/or transmitted along the length of the optical fiber 613. In addition, the DAS signal acquisition system 612 can receive DAS measurement values from a bottom hole gauge carrier 614 that transmits measurements through the optical fiber 613. In some embodiments, the bottom hole gauge carrier 614 can include a pressure temperature gauge and can be inside of or replaced by a wireline scanning tool.

DAS measurement values transmitted through the optical fiber 613 can be sent to the DAS signal acquisition system 612 at the surface. The DAS interrogator of the DAS signal acquisition system 612 can be electrically connected to a digitizer to convert optically-transmitted measurements into digitized measurements. A computing device 610 can collect the electrically-transmitted measurements from the DAS signal acquisition system 612 using a connector 625. The computing device can have one or more processors and a memory device to analyze the measurements and graphically represent analysis results on the display device 650. In addition, the computing device 610 can communicate with components attached to the optical fiber 613. For example, the computing device 610 can send control signals to the bottom hole gauge carrier 614 to modify gauge measurement parameters. Additionally, in some embodiments, at least one processor and memory device can be located downhole for the same purposes. With the optical fiber 613 positioned inside a portion of the borehole 603, the DAS signal acquisition system 612 can obtain information associated with the subterranean formation 602 based on seismic/acoustic disturbances (e.g. seismic disturbances and/or formation reflections caused by signals from the seismic source 615). Relative to other positions, fixing the optical fiber 613 to the outer perimeter of the tubing 609 can increase the sensitivity of DAS measurements to changes in the annular region between the production casing 607 and the tubing 609. (e.g. changes in fluid flow down the tubing 609, changes in fluid composition down the tubing 609, etc.).

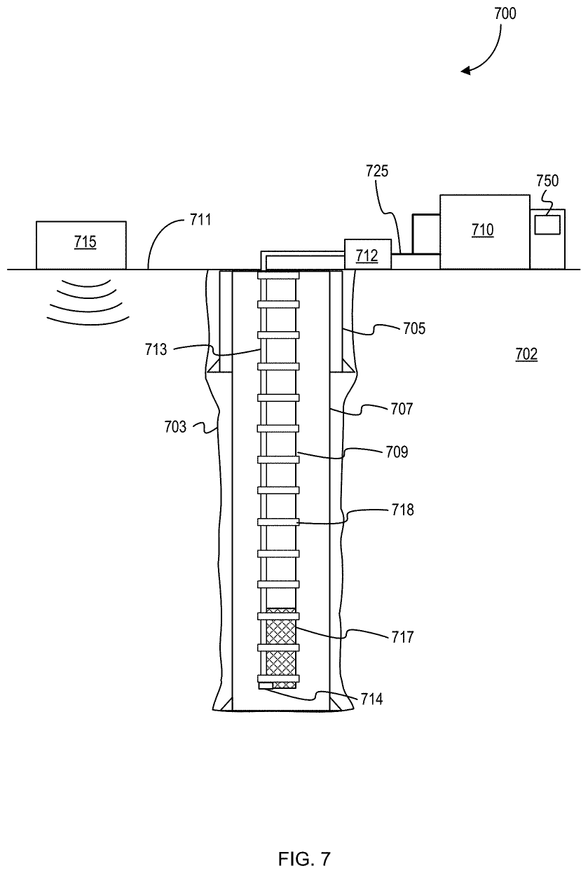

FIG. 7 is an elevation view of a borehole that includes a simultaneous DAS signal acquisition system connected to an optical fiber fixed to the outside of the tubing of a cased borehole. A borehole 703 in the subterranean formation 702 includes a DAS system 700 that can detect seismic disturbances generated by a seismic source 715 on an earth surface 711. The borehole 703 can be a completion well (i.e. a well ready for production or injection following a drilling process) having a surface casing 705, a production casing 707 inside the surface casing 705, and a tubing 709 inside the production casing 707. In some embodiments, the tubing 709 can be a casing string, production string, an armored wireline, a slickline, a coiled tubing, a work string, etc. The DAS system 700 includes an optical fiber 713 that is fixed to the outer perimeter of the tubing 709. Cross-coupling protectors such as a cross-coupling protector 718 can be used to fix the optical fiber 713 to the tubing 709. In addition, a tubing tail 717 can also be fixed to the optical fiber 713 and extend below the bottom of the tubing 709.

In some embodiments, the optical fiber can be connected to a DAS signal acquisition system 712 that includes a DAS interrogator. The DAS interrogator in the DAS signal acquisition system 712 can be directly coupled to the optical fiber 713. Alternatively, the DAS interrogator can be coupled to a fiber stretcher module in the DAS signal acquisition system 712, wherein the fiber stretcher module is coupled to the optical fiber 713. The DAS signal acquisition system 712 can receive DAS measurement values taken and/or transmitted along the length of the optical fiber 713. In addition, the DAS signal acquisition system 712 can receive DAS measurement values from a bottom hole gauge carrier 714 that transmits measurements through the optical fiber 713. In some embodiments, the bottom hole gauge carrier 714 can include a pressure temperature gauge and can be inside of or replaced by a wireline tool.

DAS measurement values transmitted through the optical fiber 713 can be sent to the DAS signal acquisition system 712 at the surface. The DAS interrogator of the DAS signal acquisition system 712 can be electrically connected to a digitizer to convert optically-transmitted measurements into digitized measurements. A computing device 710 can collect the electrically-transmitted measurements from the DAS signal acquisition system 712 using a connector 725. The computing device can have one or more processors and a memory device to analyze the measurements and graphically represent analysis results on the display device 750. In addition, the computing device 710 can communicate with components attached to the optical fiber 713. For example, the computing device 710 can send control signals to the bottom hole gauge carrier 714 to modify gauge measurement parameters. Additionally, in some embodiments, at least one processor and memory device can be located downhole for the same purposes. With the optical fiber 713 positioned inside a portion of the borehole 703, the DAS signal acquisition system 712 can obtain information associated with the subterranean formation 702 based on seismic/acoustic disturbances (e.g. seismic disturbances caused by the seismic source 715). Relative to other positions, fixing the optical fiber 713 to the outer perimeter of the tubing 709 can increase the sensitivity of DAS measurements to changes in the annular region between the production casing 707 and the tubing 709.

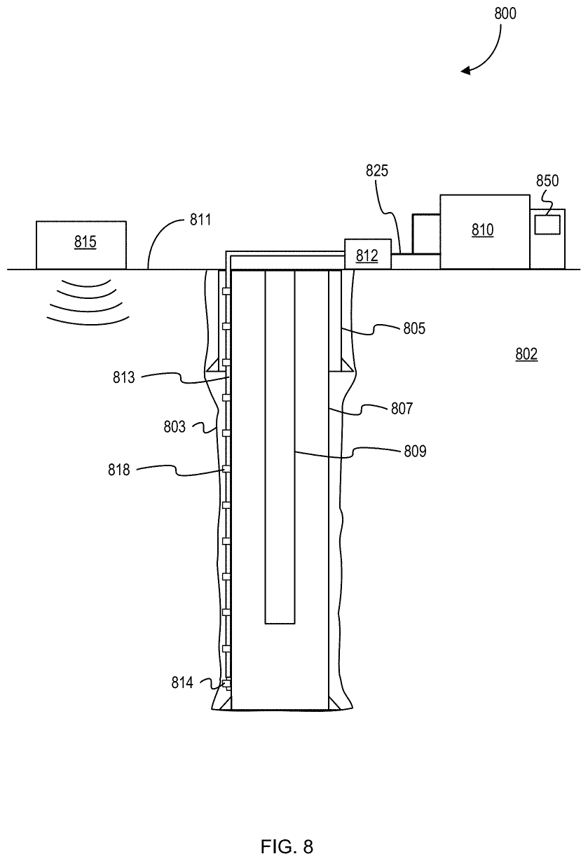

FIG. 8 is an elevation view of a borehole that includes a simultaneous DAS signal acquisition system connected to an optical fiber fixed to the outside of the production casing of a cased borehole. A borehole 803 in the subterranean formation 802 includes a DAS system 800 that can detect seismic disturbances generated by a seismic source 815 on an earth surface 811. The borehole 803 can be a completion well (i.e. a well ready for production or injection following a drilling process) having a surface casing 805, a production casing 807 inside the surface casing 805, and a tubing 809 inside the production casing 807. In some embodiments, the tubing 809 can be a casing string, production string, an armored wireline, a slickline, a coiled tubing, a work string, etc. The DAS system 800 includes an optical fiber 813 that is fixed to the outer perimeter of the production casing 809. Cross-coupling protectors such as a cross-coupling protector 818 can be used to fix the optical fiber 813 to the outer perimeter of the production casing 809.

In some embodiments, the optical fiber can be connected to a DAS signal acquisition system 812 that includes a DAS interrogator. The DAS interrogator in the DAS signal acquisition system 812 can be directly coupled to the optical fiber 813. Alternatively, the DAS interrogator can be coupled to a fiber stretcher module in the DAS signal acquisition system 812, wherein the fiber stretcher module is coupled to the optical fiber 813. The DAS signal acquisition system 812 can receive DAS measurement values taken and/or transmitted along the length of the optical fiber 813. In addition, the DAS signal acquisition system 812 can receive DAS measurement values from a bottom hole gauge carrier 814 that transmits measurements through the optical fiber 813. In some embodiments, the bottom hole gauge carrier 814 can include a pressure temperature gauge and can be inside of or replaced by a wireline tool, etc.

DAS measurement values transmitted through the optical fiber 813 can be sent to the DAS signal acquisition system 812 at the surface. The DAS interrogator of the DAS signal acquisition system 812 can be electrically connected to a digitizer to convert optically-transmitted measurements into digitized measurements. A computing device 810 can collect the electrically-transmitted measurements from the DAS signal acquisition system 812 using a connector 825. The computing device can have one or more processors and a memory device to analyze the measurements and graphically represent analysis results on the display device 850. In addition, the computing device 810 can communicate with components attached to the optical fiber 813. For example, the computing device 810 can send control signals to the bottom hole gauge carrier 814 to modify gauge measurement parameters. Additionally, in some embodiments, at least one processor and memory device can be located downhole for the same purposes. With the optical fiber 813 positioned inside a portion of the borehole 803, the DAS signal acquisition system 812 can obtain information associated with the subterranean formation 802 based on seismic/acoustic disturbances (e.g. seismic disturbances caused by the seismic source 815). Relative to other positions, fixing the optical fiber 813 to the outer perimeter of the production casing 809 can increase the sensitivity of DAS measurements to changes in the formation.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine-readable medium may be a machine-readable signal medium or a machine readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

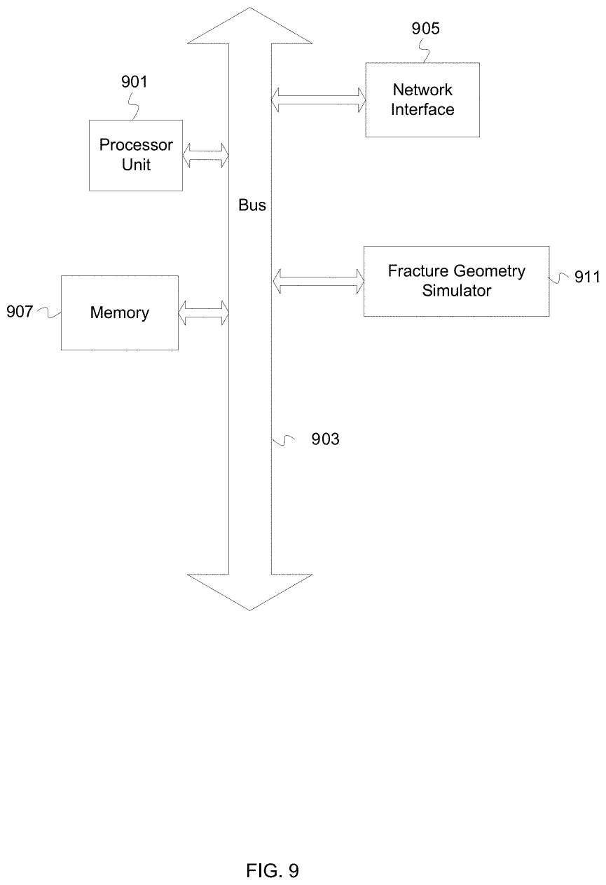

FIG. 9 depicts an example computer system for multi-well fracture control. The computer system includes a processor 901 (possibly including multiple processors, multiple cores, multiple nodes, and/or implementing multi-threading, etc.). The computer system includes memory 907. The memory 907 may be system memory or any one or more of the above already described possible realizations of machine-readable media. The computer system also includes a bus 903 and a network interface 905. The system communicates via transmissions to and/or from remote devices via the network interface 905 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.). The system also includes a fracture geometry simulator 911. The fracture geometry simulator 911 includes code to perform operations of configuring fracture geometry models and simulating fracture growth. Any one of the previously described functionalities may be partially (or entirely) implemented in hardware and/or on the processor 901. For example, the functionality may be implemented with an application specific integrated circuit, in logic implemented in the processor 901, in a co-processor on a peripheral device or card, etc. Further, realizations may include fewer or additional components not illustrated in FIG. 9 (e.g., video cards, audio cards, additional network interfaces, peripheral devices, etc.). The processor 901 and the network interface 905 are coupled to the bus 903. Although illustrated as being coupled to the bus 903, the memory 907 may be coupled to the processor 901.

While the aspects of the disclosure are described with reference to various implementations and exploitations, it will be understood that these aspects are illustrative and that the scope of the claims is not limited to them. In general, techniques for multi-well fracture control as described herein may be implemented with facilities consistent with any hardware system or hardware systems. Many variations, modifications, additions, and improvements are possible.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Example Embodiments

A method comprises configuring a fracture geometry model based, at least in part, on measured properties for a first well and measured properties for a second well. The measured properties for the first well and the second well were measured during a period of fluid injection operations of the first well. The method further comprises varying input parameters into the configured fracture geometry model to simulate multiple realizations depicting the earth formation surrounding the first and second wells, evaluating results of the simulation of multiple realizations against the configured fracture geometry model to determine one or more simulated results within a variance of the measured properties, determining fracture growth parameters based on the evaluated results, and predicting a well interference event based, at least in part, on the determined fracture growth parameters.

Predicting the well interference event comprises determining a time and a location of the well interference event based on the determined fracture growth parameters. The method of further comprises initiating a treatment action in anticipation of the time and the location of the well interference events to mitigate impact in the second well. Initiating the treatment action comprises at least one of pressure loading the second well, reducing the pumping rate to the first well, adding diverters to the first well, adding proppant to the first well, and adding surfactants to the fluid injected into the first well.

Configuring the fracture geometry model comprises constraining a historical fracture geometry model with the measured properties for the first well and the measured properties for the second well.

Evaluating results of the simulation of multiple realizations against the configured fracture geometry model to determine one or more simulated results within a variance of the measured properties comprises comparing the results of the simulation of multiple realizations to the measured properties for the first well and the measured properties for the second well and selecting one or more of the multiple realizations based on the comparison.

The measured properties comprise at least of one of pressure, temperature, strain and acoustic responses.

A system comprises a processor and a machine-readable medium. The machine-readable medium has program code executable by the processor to cause the system to configure a fracture geometry model based, at least in part, on measured properties for a first well and measured properties for a second well. The measured properties for the first well and the second well were measured during a period of fluid injection operations of the first well. The machine-readable medium further has program executable by the processor to cause the system to vary input parameters into the configured fracture geometry model to simulate multiple realizations depicting an earth formation surrounding the first and second wells, evaluate results of the simulation of the multiple realizations against the configured fracture geometry model to determine one or more simulated results within a variance of the measured properties, determine fracture growth parameters based on the evaluated results, and predict a well interference event based, at least in part, on the determined fracture growth parameters.

The program code to predict the well interference event comprises program code executable by the processor to cause the system to determine a time and a location of the well interference event based on the determined fracture growth parameters. The machine-readable medium having program code executable by the processor further causes the system to initiate treatment actions with an electrical pump in anticipation of the time and the location of the well interference events to mitigate impact in the second well. The program code to initiate treatment actions with the electrical pump comprises program code executable by the processor to cause the system to perform at least one of pressure loading the second well and reducing the pumping rate to the first well.

The program code to configure the fracture geometry model comprises program code to constrain a historical fracture geometry model with the measured properties for the first well and the measured properties for the second well. The program code to constrain a historical fracture geometry model with the measured properties for the first well and the measured properties for the second well comprises program code to couple the measured properties for the first and second wells to historical data to adjust and fine tune a modeled output.

The program code to evaluate results of the simulation of multiple realizations against the configured fracture geometry model to determine one or more simulated results within a variance of the measured properties comprises program code to compare the results of the simulation of multiple realizations to the measured properties for the first well and the measured properties for the second well and select one or more of the multiple realizations based on the comparison.

The program code to constrain a historical fracture geometry model with the measured properties for the first well and the measured properties for the second well comprises program code to generate a historical fracture geometry model, generate a model representing the measured properties of the first well and the measured properties of the second well, and couple the historical fracture geometry model and the model representing the measured properties of the first well and the measured properties of the second well. The program code to couple the historical fracture geometry model and the model representing the measured properties of the first well and the measured properties of the second well comprises the program code to couple the historical fracture geometry model and the model representing the measured properties of the first well and the measured properties of the second well to match a simulated formation corresponding to the coupled models to a physical formation.

One or more non-transitory machine-readable media comprises program code for well interference event control. The program code is to obtain, from a first set of sensors, properties for a first well during a period of fluid injection operations of the first well, obtain, from a second set of sensors, properties for a second well during the period of fluid injection operations of the first well, configure a fracture geometry model based, at least in part, on the obtained properties for the first well and the obtained properties for the second well, vary input parameters into the configured fracture geometry model to simulate multiple realizations depicting an earth formation surrounding the first and second wells, evaluate results of the simulation of multiple realizations against the configured fracture geometry model to determine one or more simulated results within a variance of the measured properties, determine fracture growth parameters based on the evaluated results, and predict a well interference event based, at least in part, on the determined fracture growth parameters.

The program code to evaluate results of the simulation of multiple realizations against the configured fracture geometry model to determine one or more simulated results within a variance of the measured properties comprises program code to compare the results of the simulation of multiple realizations to the obtained properties for the first well and the obtained properties for the second well and select one or more of the multiple realizations based on the comparison.

The program code to configure the fracture geometry model comprises program code to constrain a historical fracture geometry model with the obtained properties for the first well and the obtained properties for the second well.

The program code to predict the well interference event comprises program code to determine a time and a location of the well interference event based on the determined fracture growth rate.

What is claimed is:

1. A method comprising:
configuring a fracture geometry model based, at least in part, on measured properties for a first well and measured properties for a second well, wherein the measured properties for the first well and the second well were measured during a period of fluid injection operations of the first well;
varying input parameters into the configured fracture geometry model to simulate multiple realizations depicting an earth formation surrounding the first and second wells;
evaluating results of the simulation of multiple realizations against the configured fracture geometry model to determine one or more simulated results within a variance of the measured properties;
determining fracture growth parameters based on the evaluated results; and
predicting a well interference event based, at least in part, on the determined fracture growth parameters.

2. The method of claim 1, wherein predicting the well interference event comprises determining a time and a location of the well interference event based on the determined fracture growth parameters.

3. The method of claim 2, further comprising initiating a treatment action in anticipation of the time and the location of the well interference events to mitigate impact in the second well.

4. The method of claim 3, wherein initiating the treatment action comprises at least one of pressure loading the second well, reducing the pumping rate to the first well, adding diverters to the first well, adding proppant to the first well, and adding surfactants to the fluid injected into the first well.

5. The method of claim 1, wherein configuring the fracture geometry model comprises constraining a historical fracture geometry model with the measured properties for the first well and the measured properties for the second well.

6. The method of claim 1, wherein evaluating results of the simulation of multiple realizations against the configured fracture geometry model to determine one or more simulated results within a variance of the measured properties comprises:
comparing the results of the simulation of multiple realizations to the measured properties for the first well and the measured properties for the second well; and
selecting one or more of the multiple realizations based on the comparison.

7. The method of claim 1, wherein the measured properties comprise at least of one of pressure, temperature, strain and acoustic responses.

8. A system comprising:
a processor; and
a machine-readable medium having program code executable by the processor to cause the system to,
configure a fracture geometry model based, at least in part, on measured properties for a first well and measured properties for a second well, wherein the measured properties for the first well and the second well were measured during a period of fluid injection operations of the first well;
vary input parameters into the configured fracture geometry model to simulate multiple realizations depicting an earth formation surrounding the first and second wells;
evaluate results of the simulation of the multiple realizations against the configured fracture geometry model to determine one or more simulated results within a variance of the measured properties;
determine fracture growth parameters based on the evaluated results; and
predict a well interference event based, at least in part, on the determined fracture growth parameters.

9. The system of claim 8, wherein the program code to predict the well interference event comprises program code executable by the processor to cause the system to determine a time and a location of the well interference event based on the determined fracture growth parameters.

10. The system of claim 9, further comprising the machine-readable medium having program code executable by the processor to cause the system to initiate treatment actions with an electrical pump in anticipation of the time and the location of the well interference events to mitigate impact in the second well.

11. The system of claim 10, wherein the program code to initiate treatment actions with the electrical pump comprises program code executable by the processor to cause the system to, at least one of, pressure load the second well and reduce the pumping rate to the first well.

12. The system of claim 8, wherein the program code to configure the fracture geometry model comprises program code to constrain a historical fracture geometry model with the measured properties for the first well and the measured properties for the second well.

13. The system of claim 12, wherein the program code to constrain a historical fracture geometry model with the measured properties for the first well and the measured properties for the second well comprises program code to couple the measured properties for the first and second wells to historical data to adjust and fine tune a modeled output.

14. The system of claim 8, wherein the program code to evaluate results of the simulation of multiple realizations against the configured fracture geometry model to determine one or more simulated results within a variance of the measured properties comprises program code to:
compare the results of the simulation of multiple realizations to the measured properties for the first well and the measured properties for the second well; and
select one or more of the multiple realizations based on the comparison.

15. The system of claim 8, wherein the program code to constrain a historical fracture geometry model with the measured properties for the first well and the measured properties for the second well comprises program code to:
generate a historical fracture geometry model;
generate a model representing the measured properties of the first well and the measured properties of the second well; and
couple the historical fracture geometry model and the model representing the measured properties of the first well and the measured properties of the second well.

16. The system of claim 15, wherein the program code to couple the historical fracture geometry model and the model representing the measured properties of the first well and the measured properties of the second well comprises the program code to couple the historical fracture geometry model and the model representing the measured properties of the first well and the measured properties of the second well to match a simulated formation corresponding to the coupled models to a physical formation.

17. One or more non-transitory machine-readable media comprising program code for well interference event control, the program code to:
obtain, from a first set of sensors, properties for a first well during a period of fluid injection operations of the first well;
obtain, from a second set of sensors, properties for a second well during the period of fluid injection operations of the first well;
configure a fracture geometry model based, at least in part, on the obtained properties for the first well and the obtained properties for the second well;
vary input parameters into the configured fracture geometry model to simulate multiple realizations depicting an earth formation surrounding the first and second wells;
evaluate results of the simulation of multiple realizations against the configured fracture geometry model to determine one or more simulated results within a variance of the measured properties;
determine fracture growth parameters based on the evaluated results; and
predict a well interference event based, at least in part, on the determined fracture growth parameters.

18. The one or more non-transitory machine-readable media of claim 17, wherein the program code to evaluate results of the simulation of multiple realizations against the configured fracture geometry model to determine one or more simulated results within a variance of the measured properties comprises program code to:
compare the results of the simulation of multiple realizations to the obtained properties for the first well and the obtained properties for the second well; and
select one or more of the multiple realizations based on the comparison.

19. The one or more non-transitory machine-readable media of claim 17, wherein the program code to configure the fracture geometry model comprises program code to constrain a historical fracture geometry model with the obtained properties for the first well and the obtained properties for the second well.

20. The one or more non-transitory machine-readable media of claim 17, wherein the program code to predict the well interference event comprises program code to determine a time and a location of the well interference event based on the determined fracture growth rate.
